(19) United States
(12) Patent Application Publication
(10) Pub. No.: US 2004/0240661 A1
(43) Pub. Date: Dec. 2, 2004

(54) Telephone apparatus and a private branch exchange

(75) Inventor: Katsuya Matsufuji, Miyake-gun (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/799,853

(22) Filed: Mar. 15, 2004

(30) Foreign Application Priority Data
Mar. 14, 2003 (JP) 2003-069995

(51) Int. Cl. H04M 13/00; H04M 3/00; H04M 1/00

(52) U.S. Cl. 379/355.02

(57) ABSTRACT

Providing a telephone apparatus and a PBX which can properly perform redialing including sending of a personal ID to a called telephone apparatus even in case the telephone apparatus has to input a personal ID over a DTMF signal after it has answered the call

According to the invention, the input dial information is sequentially stored into a redial table. On detection of a connection signal, mark information is stored into the redial table. In case dial information is further input, the dial information is sequentially stored into storage means until the call is released. On a redial request, the dial information before the mark information out of the dial information stored in the redial table is output to the control channel of a digital communications line while the dial information after the mark information is output to the voice channel of the digital communications line after a connection signal from the digital communications line is detected.

### BACKGROUND OF THE INVENTION

1. Field of the Invention

The present invention relates to a telephone apparatus such as a pushbutton telephone apparatus and a private branch exchange (hereinafter referred to as PBX) having a redial feature, and in particular to such a PBX.

2. Description of the Related Art

In the related art, a telephone apparatus has been available which is equipped with a feature to store a dialed number on a telephone line and uses the stored information to dial the same number (for example refer to the Japanese Patent Laid-Open No. 49463/1989).

However, on such a related art telephone apparatus, in case the called telephone apparatus has to input a personal ID over a DTMF signal after answering the call, transmitting stored dial information to the telephone line in succession outputs the dial information before the called telephone apparatus answers the call. Thus it is not possible to receive on the called telephone apparatus a personal ID to be input over a DTMF signal after it has answered the call.

### SUMAMRY OF THE INVENTION

In view of the problems, the invention aims at providing a telephone apparatus and a PBX which can properly perform redialing including sending of a personal ID to a called telephone apparatus even in case the telephone apparatus has to input a personal ID over a DTMF signal after it has answered the call.

In order to solve the problems, the invention provides a telephone apparatus which can be connected to a digital communication line comprising at least a control channel and a voice channel, the telephone apparatus comprising dial information storage control means for sequentially storing dial information input from input means and storing predetermined information into the storage means on detecting a connection signal from a digital communications line and, in case further dial information is input from the input means, sequentially storing the dial information into the storage means until the call is released, and redial control means for outputting to a control channel of a digital communications line dial information stored before predetermined information out of the dial information stored into the storage means and, on detecting a connection signal from the digital communications line, outputting dial information stored after the predetermined information to a voice channel of the digital communication line.

With this configuration, it is possible to provide a telephone apparatus and a PBX which can properly perform redialing including sending of a personal ID to a called telephone apparatus even in case the telephone apparatus has to input a personal ID over a DTMF signal after it has answered the call.

### BRIEF DESCRIPTION OF THE DRAWINGS

FIG. 1 is a block diagram of a PBX according to Embodiment 1 of the invention;

FIG. 2 shows the redial table for the PBX according to Embodiment 1 of the invention;

FIG. 3 is a sequence chart showing the operation of storing redial information in the PBX according to Embodiment 1 of the invention; and

FIG. 4 is a sequence chart showing the operation of redial origination in the PBX according to Embodiment 1 of the invention.

### DESCRIPTION OF THE PREFERRED EMBODIMENTS

Embodiments of the invention are described below referring to drawings.

(Embodiment 1)

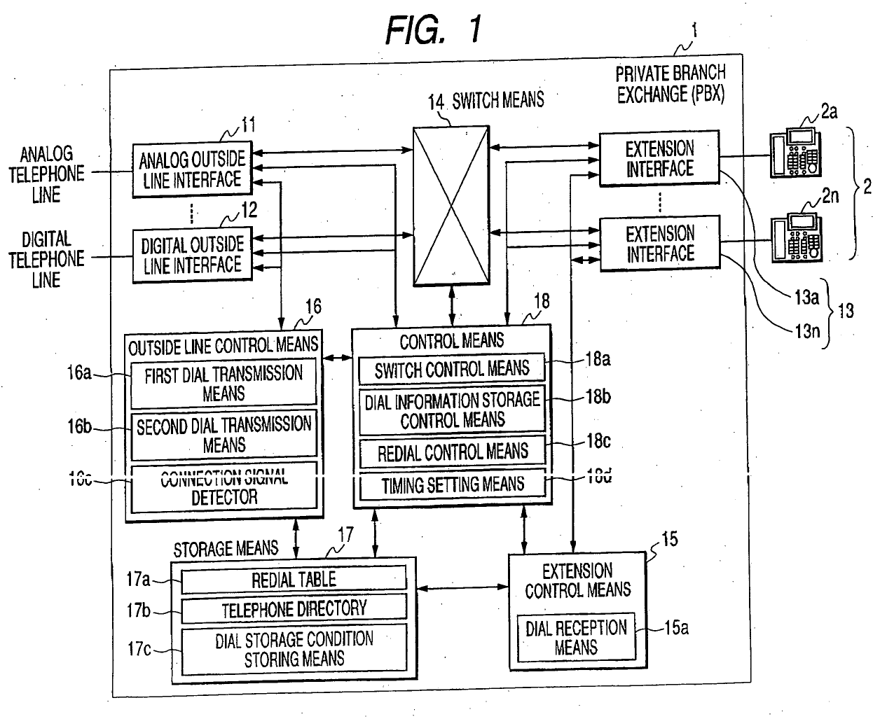

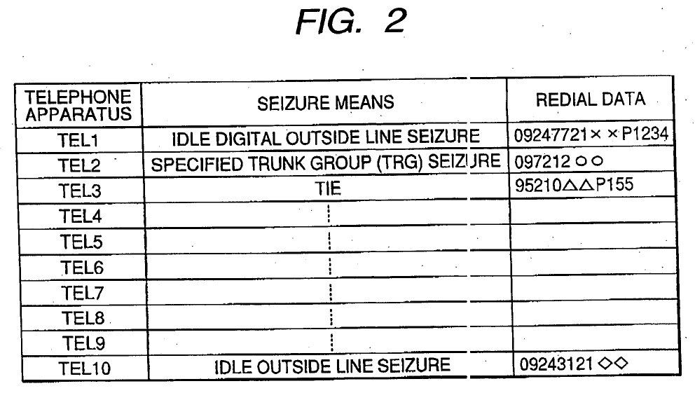

FIG. 1 is a block diagram of a PBX according to Embodiment 1 of the invention. FIG. 2 shows the redial table for the PBX according to Embodiment 1 of the invention.

In FIG. 1, a numeral 1 represents a PBX and 2, 2a, . . . , 2n an extension station. The extension station 2 is a generic name for the extension stations 2a, . . . , 2n. The overall configuration including the PBX 1 and the extension station 2 is generally referred to as a telephone apparatus according to the invention. The internal configuration of the PBX will be described in detail.

A numeral 11 represents an analog outside line interface for connecting to and communicating with an analog telephone line (analog communication line of Embodiment 1 of the invention), 12 a digital outside line interface for connecting to and communicating with a digital telephone line comprising a control channel and a voice channel (digital communications line of Embodiment 1 of the invention), and 13, 13a-13n an extension interface for connecting an extension station. The extension interface 13 is a generic name for the extension interfaces 13a through 13n. A numeral 14 represents switch means for connecting and disconnecting a sound signal transmitted between the analog outside line interfaces 11, digital outside line interface 12, and extension interface 13.

A numeral 15 represents extension control means for performing display control, function control and call control of the extension station 2 via the extension interface, and 15a dial reception means. The dial reception means 15a serves as function implementation means in the extension control means 15. The dial reception means 15a receives dial information transmitted from the extension station 2 via the extension interface.

A numeral 16 represents outside line control means for controlling call origination to a telephone line from the analog outside line interface 11 or digital outside line interface or control call termination from the telephone line to the analog outside line interface 11 or digital outside line interface 12. As similar function implementation means, first dial transmission means 16a, a second dial transmission means 16b and line connection acknowledgment detection means 16c are provided.

The first dial transmission means 16a outputs a dial signal corresponding to the dial information received by the dial reception means 15a from the digital outside line interface 12 to the control channel of the digital communications line. The second dial transmission means 16a outputs a dial signal corresponding to the dial information received by the dial reception means 15a as a DTMF signal to the analog telephone line via the analog outside line interface 11 or to the voice channel of the digital communications line via the digital outside line interface 12.

The line connection acknowledgment detection circuit 16c causes the outside line control means 16 to seize an outside line by way of the digital outside line interface 12 and after dialing from the first dial signal transmission means 16b, detects whether a line connection acknowledgment has been received from the digital communications line.

A numeral 17 represents storage means for storing a program, various setting information, a redial table 17a and a telephone directory 17b, as well as dial storage condition storing means 17c.

The redial table 17a stores dial information received by the dial reception means 15a in order to perform redialing from the extension station 2. In the redial table 17a is registered a dial number by dial information storage control means 18b when the dial number is originated from the extension station to a telephone line via the analog outside line interface 11 or digital outside line interface 12. When a redial button (not shown) on the extension station 2 is pressed, the extension control means 15 of the PBX 1 detects the press on the redial button and the redial data of the extension station whose redial button is pressed is fetched from the redial table 17a. The redial data is transmitted to a telephone line by the first dial transmission means 16a or second dial transmission means 16b via the analog outside line interface 11 or digital outside line interface 12.

For example, assume that redial information is registered to the redial table 17a as shown in FIG. 2. When the redial button of the extension station 1 (“Tel 1”), the redial table 17a is referenced by the redial control means 18c mentioned later. Redial data (09247721XXP1234) corresponding to the extension station 1 and the seizure means information mentioned later (see FIG. 2) are fetched from the redial table 17a. Based in the fetched seizure means information, a target outside line interface is selected, then the fetched redial data is output from the selected outside line interface.

Next, the telephone directory 17b is a telephone directory which stores dial information and destination information in correspondence to each other.

The dial storage condition storing means 17c stores the conditions on whether the dial information storage control means 18b stores into the redial table 17a the dial information received by the dial reception means 15a after the connection signal detector 16c has detected a line connection acknowledgment from a digital communications line. The content of the dial information storage control means 18b can be set in response to a request issued by the extension station 2 or on the setting screen of a computer connected to the PBX 1.

A numeral 18 represents control means for controlling the entire PBX and comprises, as function implementation means, switch control means 18a, dial information storage control means 18b, redial control means 18c, and timing setting means 18d.

The switch control means 18a connects the extension station 2 and the voice channel of the digital communications line when the connection signal detector 16c has detected a line connection acknowledgment.

The dial information storage control means 18b sequentially stores dial information received by the dial reception means 15a into the redial table 17a. The dial information storage control means 18b, detecting a connection signal from the digital communications line on the connection signal detector 16c, generates mark information. The dial information storage control means 18b stores the mark information into the redial table 17a. After that, the dial information storage control means 18b, receiving a dial signal on the dial reception means 15a, sequentially stores the received dial information as redial information of the extension station 2 into the redial table 17a until the extension station 2 releases the call.

Next, the redial control means 18c, on redial origination via redial button operation, outputs dial information before mark information (information to be marked to separate dial information at a certain point; the mark information corresponding to the predetermined information of the invention) out of the dial information stored by the dial information storage control means 18b to the control channel of the digital communications line by way of the first dial signal transmission means 16a. The redial control means 18c outputs the information after the mark information to the vice channel of the digital communications line by way of the second dial signal transmission means 16b after the connection signal detector 16c has detected an acknowledgment from the digital communications line.

The timing setting means 18d has a function to set a timing of outputting dial information by way of the second dial signal transmission means 16b. The redial control means 18c, on detection of an acknowledgment from the digital communications line by way of the connection signal detector 16c, outputs the dial information stored after predetermined information to the voice channel of the digital communications line by way of the second dial signal transmission means 16b based on the timing set by the timing setting means 18d.

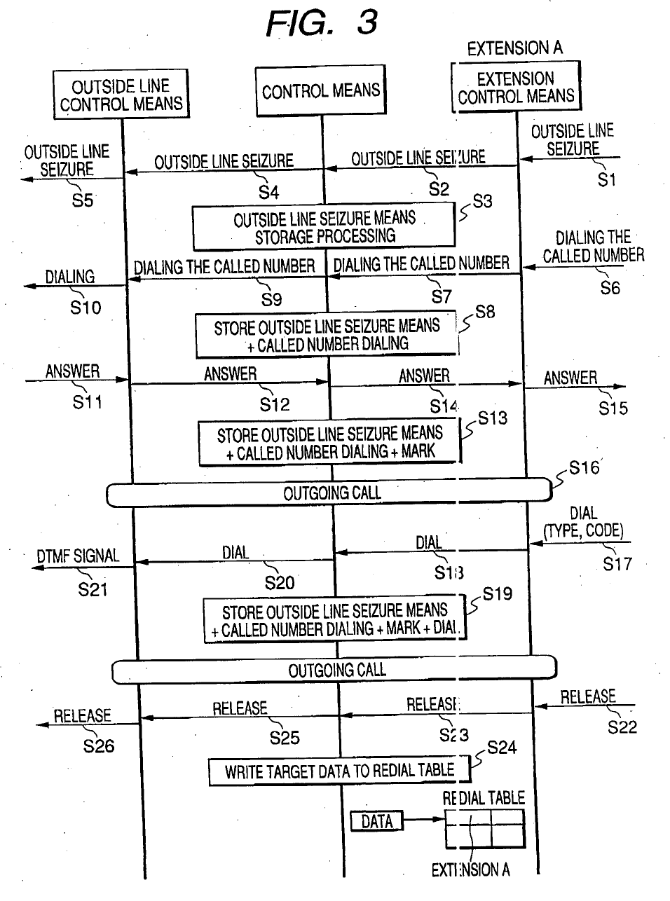

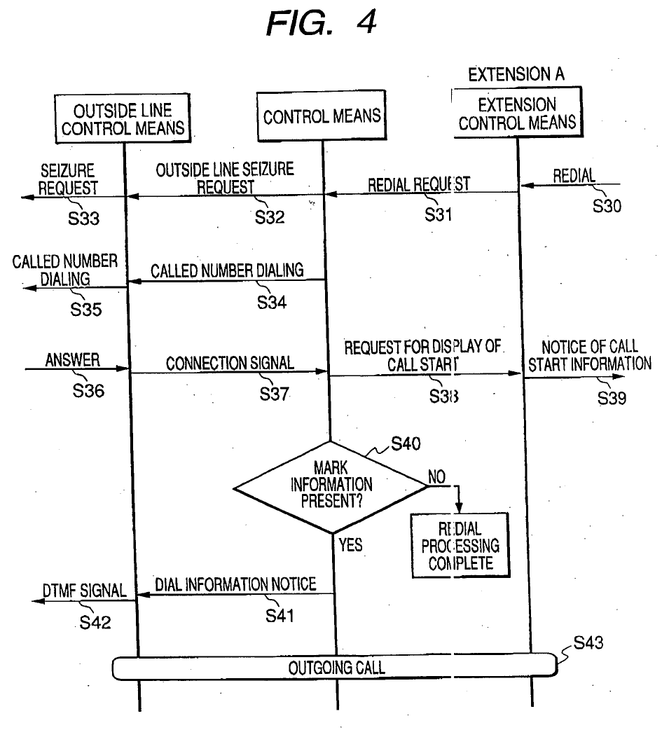

Operation of the PBX thus configured is described below referring to the sequence charts of FIGS. 3 and 4.

FIG. 3 is a sequence chart showing the operation of storing redial information in the PBX according to Embodiment 1 of the invention. FIG. 4 is a sequence chart showing the operation of redial origination in the PBX according to Embodiment 1 of the invention.

How the redial information is registered to the redial table is described below referring to the sequence chart of FIG. 3.

When the user of the extension station 2 operates an outside line button on the extension station 2 or enters a prefix (such as a number for specifying an outside line interface or a number to seize an idle outside line) for outgoing call by way of a ten-key pad on the extension station 2, the information is received by the extension control means 15 or dial reception means 15a via the extension interface 13 (S1).

The information received by the extension control means 15 or dial reception means 15a is communicated to the call control means (not shown) of the control means 18 (S2). The call control means identifies that the information is outside line seizure information and registers, or stores outside line seizure means into, the information of the outside line seizure means including idle outside line seizure, idle digital outside line seizure and specified trunk group (TRG) seizure to the redial table 17a in correspondence to the originating extension station.

The idle outside line seizure means call origination by using an idle outside line interface among the plurality of outside line interfaces (which means hereinafter speech channels of a single outside line interface in case such a configuration is available as in an ISDN line) preset per extension station. The idle digital outside line seizure refers to the aforementioned idle outside line seizure where the available outside line interfaces are limited to predetermined digital outside line interfaces 12. The specified trunk group (TRG) seizure means call origination to a telephone line through use (seizure) of an outside line interface corresponding to a trunk group number by dialing the trunk group number.

The call control means of the control means 18 selects an outside line interface in accordance with the received outside line seizure information and issues an outside line seizure request to the outside line control means 16 (S4). Receiving the outside line seizure request, the outside line control means 16 issues a seizure request to a telephone line (S5). The seizure request is made by forming a DC loop or going off-hook in the case of an analog outside line interface 11 while it is made by transmitting a seizure request (an off-hook signal) to a digital telephone line network over a control channel in the case of a digital outside line interface 12.

After that, when a telephone number is input from the ten-key pad of the extension station 2, the dial reception means 15a receives the telephone number information (dial information) via the extension interface 13 (S6) and communicates the telephone number information to the control means 18 (S7). The control means 18 operates the dial information storage control means 18b to sequentially register the received dial information (store the dialed numbers) into an area in the redial table 17a corresponding to the originating extension station (S8). In case the analog outside line interface 11 is seized, when determining that dial information is not received from the extension station 2 for a predetermined period, the control means 18 assumes completion of dial transmission (completion of input of a telephone number) from the extension station 2 and completes registration to the redial table 17a and performs steps S14 through S16 mentioned later to display start of a call on the display means of the extension station 2.

The control means 18 communicates the received dial information to the first dial transmission means 16a or second dial transmission means 16b of the outside line control means 16 (S9). Whether the control means 18 communicates the received dial information to the first dial transmission means 16a or second dial transmission means 16b depends on the type of the outside line interface used for outgoing call origination. In case a telephone line is seized by the analog outside line interface 11 in S4, the dial information is communicated to the second dial transmission means 16b. In case it is seized by the digital outside line interface 12 in S4, the dial information is communicated to the first dial transmission means 16a. The first dial transmission means 16a transmits dial information communicated from the control means 18 to the control channel of the digital telephone line via the digital outside line interface 12. The second dial transmission means 16b converts the dial information communicated from the control means 18 to a DTMF signal and transmits the DTMF signal to the analog telephone line via the analog outside line interface 11 (S10).

When the called party having the telephone number dialed by the extension station 2 answers after dial information is transmitted to a telephone line, in case the call is originated from the digital outside line interface 12, information that the called party answered from the digital telephone line network (for instance, in case that the digital telephone line is ISDN, the information correspond to a connect message, in case that the digital telephone line is E1, the information corresponds to E1, hereinafter the information is referred to as the connection signal) is communicated to the control channel of the digital telephone line. The information is received by the connection signal detector 16c (S11). From the connection signal detector 16c the information of connection signal is communicated to the control means 18 (S12). Receiving the information of connection signal, the control means 18 requests the dial information storage control means 18b to store mark information into the area in the redial table 17a corresponding to the originating extension station. The dial information storage control means 18b registers a mark signal to (stores a mark into) the redial table 17a in accordance with the request (S13). Receiving the notice of the information of connection signal, the control means 18 requests the extension control means 15 to display start of a call (S14). The extension control means 15 transmits to the extension station 2 the information to be displayed on the display means of the extension station 2 (call start information). The extension station 2 displays start of a call on the display means in accordance with the transmitted information (S15). The control means 18 controls the digital outside line interface 12 and extension interface 13 to establish a speech path between the extension station 2 which has originated an outgoing call and the digital telephone line connected to the digital outside line interface 12 which has made a seizure and dial output (S16).

After the speech path between the digital telephone line network and the extension station 2 has been established, when the user of the extension station 2 presses the keys on the ten-key pad to dial a number, the input dial information is received by the dial reception means 15a via the extension interface 13 (S17). The dial information received by the dial reception means 15a is communicated to the control means 18 (S18). Receiving the dial information, the control means 18 requests the dial information storage control means 18b to store the received dial information into the area in the redial table 17a corresponding to the originating extension station. The dial information storage control means 18b sequentially registers the dial information (stores the dialed number) transmitted from the extension station 2 to the redial table 17a in accordance with the request (S19). In case the dial information received by the dial reception means 15a is an extension station 2 without the DTMF signal output function, the control means 18 communicates the received dial information to the second dial transmission means 15c (S20) The second dial transmission means converts the received dial information to a DTMF signal and transmits the DTMF signal to the voice channel of the digital telephone line via the digital outside line interface 12. In case the dial information transmitted from the extension station2 is a DTMF signal rather than digital control data in D17, the DTMF signal is transmitted to the voice channel of the digital telephone line via the speech path between the digital line network and the extension station 2. The steps S20 and S21 are thus skipped.

When the user of the extension station 2 goes on-hook in a call (releases the call) connected to the user of the called telephone apparatus connected to the digital telephone line network, the off-hook information is received by the extension control means 15 (S22) and communicated to the control means 18 by way of the extension control means 15 (S23). The control means 18 completes writing the data to the area in the redial table 17a corresponding to the originating extension station (S24) and issues a line disconnection request to the outside line control means 16 (S25). The outside line control means 16 transmits the line disconnection request to the digital telephone line network via the control channel of the digital telephone line (S26).

While the dial information is directly registered to the redial table 17a in steps S3, S8, S13 and S19, the information may be stored in temporary storage means in these steps and the information stored in the temporary storage means may be written into the redial table 17a in S24.

In case the setting has been made that, after the connection signal detector 16c has detected a connection signal from the digital telephone line, the dial information carried over a dial signal received by the dial reception means 15a is not stored into the redial table 17a by way of the dial information storage control means 18b, steps S13 and S19 by the dial information storage control means 18b is skipped and data write to the redial table 17a is complete in S8 or S13.

In case a connection signal is communicated from a telephone line network even for call origination from the analog outside line interface 11, for example in the case of call origination to the analog telephone line network where a connection signal is communicated by way of inversion of the telephone line, same operation as that for origination from the digital outside line interface 12 may be performed.

Operation of redial origination from the extension station is described below referring to the sequence chart of FIG. 3.

When the user of the extension station 2 operates a redial button on the extension station 2, the information that the redial button is pressed is received by the extension control means 15 via the extension interface 13 (S30). The extension control means 15 communicates the redial request information to the redial control means 18c of the control means 18 together with the information on the extension number of the extension whose redial button was pressed (S31). The redial control means 18c fetches the information on the seizure means corresponding to the communicated extension number (telephone apparatus number) from the redial table 17a. The redial control means 18c then selects an outside line interface in accordance with the seizure means and issues an outside line seizure request to the outside line control means 16 (S32). Receiving the outside line seizure request, the outside line control means 16 issues a seizure request to the telephone line (S33). The seizure request is made by forming a DC loop or going off-hook in the case of an analog outside line interface 11 while it is made by transmitting a seizure request (an off-hook signal) to a digital telephone line network over a control channel in the case of a digital outside line interface 12.

Once the telephone line is seized, the redial control means 18c fetches the information on the dialed number (number information up to the mark information if any) from the redial table 17a and communicates the information to the outside line control means 16 (S34). Receiving the information on the dialed number, the outside line control means 16 operates the first dial transmission means 16a to output the dialed number information over the control channel of the digital telephone line in the case of the digital outside line interface 12, while it operates the second dial transmission means 16b to convert the dialed number information to a DTMF signal and transmit the DTMF signal to the analog telephone line via the analog outside line interface 11 in the case of the analog outside line interface 11 (S35). In case the analog outside line interface 11 is seized, when determining that dial information is not received from the extension station 2 for a predetermined period, the outside line control means 16 assumes completion of dial transmission (completion of input of a telephone number) from the extension station 2 and completes registration to the redial table 17a and performs steps S38, S39 and S43 mentioned later to display start of a call on the display means of the extension station 2.

When output of the dialed number is complete and the called telephone apparatus answers the call originated by the extension station 2, in case the call is originated from the digital outside line interface 12, a connection signal is communicated from the digital line network to the control channel of the digital telephone line and received by the connection signal detector 16c (S36). From the connection signal detector 16c the information of connection signal is communicated to the control means 18 (S37). Receiving the information of connection signal, the control means 18 requests the extension control means 15 to display start of a call (S38). The extension control means 15 transmits to the extension station 2 the information to be displayed on the display means of the extension station 2 (call start information). The extension station 2 displays start of a call on the display means in accordance with the information transmitted (S39).

Receiving the connection signal, the control means 18 operates the redial control means 18c to determine whether the redial data of the extension station 2 under redialing in the redial table 17a has mark information (S40). In case it has determined that the redial data has no mark information, the redial control means 18c completes the redial function processing. In case it has determined that the redial data has mark information, the redial control means 18c fetches the dial information after the mark signal in the redial table 17a and communicates the dial information to the outside line control means 16 (S41). The outside line control means 16 operates the second dial transmission means 16b to convert the dial information to a DTMF signal and output the DTMF signal to the analog telephone line via the analog outside line interface 11.

The period from the connection signal is received from the digital telephone line (S36) to when the DTMF signal is output (S42) can be arbitrarily set on the timing setting means 18d. The timing setting means 18d can be set via input from a computer (not shown) connected to the extension station 2 or PBX 1.

While dial information after the mark information is not output to the telephone line in general in the case of call origination from the analog outside line interface 111, a button to prompt output of dial information after the mark information on the extension station 2 maybe separately provided. In this case, after dial information recorded before the mark information (predetermined information according to Embodiment 1 of the invention) has been output from the analog outside line interface, the redial control means 18c, receiving the button pressing information to prompt output of dial information recorded by the extension station 1 after the mark information from the extension control means 15, outputs the dial information after the mark information.

In case a connection signal is communicated from a telephone line network even for call origination from the analog outside line interface 11, for example in the case of call origination to the analog telephone line network where a connection signal is communicated by way of inversion of the telephone line, same operation as that for origination from the digital outside line interface 12 may be performed.

The redial control means 18c may be provided as function implementation means for outside line control means 16 instead of the control means 18. The redial control means 18c may be provided as function implementation means across the control means 18 and the outside line control means 16.

The redial data registered to the redial table 17a may be fetched from the redial table 17a and displayed on the display means of the extension station 2 based on a request to the PBX 1 byway of a predetermined operation on the extension station2. It is possible to request the PBX 1 to register the redial data displayed on the display means by way of operation on the operation means (not shown) provided on the extension station 2. The PBX 1 which has received the request can fetch the target redial data from the redial table 17a and register the data to a predetermined area in the telephone directory 17b. And, in case that the digital telephone line is T1, the first dial transmission means 16a outputs the dial signal corresponding to the digital information which is received by the dial reception means to the voice channel of the digital telephone line via the digital outside line interface 12. (not to the control channel)

According to a telephone apparatus and a PBX of the invention, it is possible to properly perform redialing including sending of a personal ID to a called telephone apparatus even in case the telephone apparatus has to input a personal ID over a DTMF signal after it has answered the call. The user of an extension station who does not enter dial information after a line connection acknowledgement can set the extension station so that it will not register to a redial table the dial information after a line connection acknowledgement is detected. By doing so, even in case dial information is inadvertently input, the dial information is not transmitted in redialing.

And with this invention, it is possible to distinctively register dial information input on call origination to a telephone line and dial information input after the called party has answered and the telephone line is connected. The dial information input after line connection is transmitted after line connection in redialing. In this practice, the dial information after line connection can be fetched separately. This makes it possible to properly perform redialing including sending of a personal ID to a called telephone apparatus even in case the telephone apparatus has to input a personal ID over a DTMF signal after it has answered the call.

And with this configuration, it is possible to properly address a case where the called party is a secondary carrier such as a voice mail and the Internet and it is necessary to transmit over a DTMF signal a password and other information requested by such a secondary carrier after connection is established.

And with this configuration, it is possible, once the dial-originated call is over, to fetch the dial information in call origination from a redial table in order to register the information to the telephone directory. This enhances the convenience on the side of the user.

And with this configuration, the user of an extension station who does not enter dial information after a connection signal can set the extension station so that it will not register to a redial table the dial information after a connection signal is detected. By doing so, even in case dial information is inadvertently input from input means after a connection signal from the digital communications line is detected, the dial information is not transmitted in redialing. This prevents dial information from being transmitted after the called party has answered the call.

And with this configuration, unwanted dial information is not transmitted to an analog telephone line which has not received a connection signal.

And with this invention, it is possible to distinctively register dial information input on call origination to a telephone line and dial information input after the called party has answered and the telephone line is connected. The dial information input after line connection is transmitted after line connection in redialing. In this practice, the dial information after line connection can be fetched separately. This makes it possible to properly perform redialing including sending of a personal ID to a called telephone apparatus even in case the telephone apparatus has to input a personal ID over a DTMF signal after it has answered the call.

With this configuration, it is possible to properly address a case where the called party is a secondary carrier such as a voice mail and the Internet and it is necessary to transmit over a DTMF signal a password and other information requested by such a secondary carrier after connection is established.

With this configuration, it is possible to adjust the dial transmission time after the connection signal in the period from when the called telephone apparatus has answered the call to when input of dial information such as a password is allowed. This makes it possible to support a telephone apparatus where the time before dial information such as a password can be input is different.

And with this configuration, the user of an extension station who does not enter dial information after a connection signal can set the extension station so that it will not register to a redial table the dial information after a connection signal is detected. By doing so, even in case dial information is inadvertently input from input means after a connection signal from the digital communications line is detected, the dial information is not transmitted in redialing. This prevents dial information from being transmitted after the called party has answered the call.

And with this configuration, unwanted dial information is not transmitted to an analog telephone line which has not received a connection signal.

And, with this configuration, even in case the dialed number information, mark information and dial information originated to a digital telephone line are registered to storage means. Even in case call origination is made to an analog telephone line which has not received a connection signal in redialing, dial information after the predetermined information (mark signal) can be connected to an analog outside line by way of a predetermined operation on the extension station. Even in the case of an outgoing call on an idle outside line comprising a digital outside line interface and an analog outside line interface and in case the called telephone apparatus has to input a personal ID over a DTMF signal after answering the call, it is possible to properly perform redialing including sending of a personal ID to the called telephone apparatus.

### CROSS REFERENCE TO RELATED APPLICATION

This application is based upon and claims the benefit of priority of Japanese Patent Application No 2003-069995 filed on Mar. 14, 2003, the contents of which are incorporated herein by reference in its entirety.

What is claimed is:

1. A telephone apparatus which can be connected to a digital communication line comprising at least a control channel and a voice channel, comprising:
a dial information storage controller, which sequentially stores dial information which is input from a input unit, into a storage unit and stores predetermined information into the storage unit on detecting a connection signal from the digital communications line and, in case further dial information is input from the input unit, sequentially stores the dial information into the storage unit until the call is released; and
a redial controller, which outputs dial information stored before the predetermined information of the dial information stored into the storage unit, to a control channel of the digital communications line, and on detecting a connection signal from the digital communications line, outputs dial information stored after the predetermined information to a voice channel of the digital communication line.

2. The telephone apparatus according to claim 1, wherein the dial information to be output to the voice channel of the digital communications lines is a DTMF signal.

3. The telephone apparatus according to claim 1, further comprising:
a telephone directory storing dial information and destination information in relation to each other,
wherein, on input from the input unit, the dial information storage controller registers the dial information and destination information to the telephone directory.

4. The telephone apparatus according to claim 1, further comprising:
a dial storage condition storing unit, which stores conditions on whether the dial information storage controller stores the dial information which is input from the input unit, into the storage unit, after a line connection acknowledgement from the digital communications line has been detected.

5. The telephone apparatus according to claim 1, further comprising:
an analog outside line interface, which connects to an analog communications line;
wherein, when outputting dial information from the analog outside line interface, the redial controller does not output dial information stored after predetermined information.

6. The telephone apparatus according to claim 1, wherein:
the predetermined information is mark information generated by the dial information storage unit based on detection of the line connection acknowledgement.

7. A private branch exchange (PBX) to which an extension station can be connected, comprising:
an extension interface, which connects an extension station;
a digital outside line interface, which connects to a digital communications line comprising at least a control channel and a voice channel;
a dial receiver, which receives dial information transmitted from an extension station via the extension interface;
a first dial signal transmitter, which outputs a dial signal corresponding to the dial information received by the dial receiver to the control channel via the digital outside line interface;
a second dial signal transmitter, which outputs a dial signal corresponding to the dial information received by the dial receiver to the voice channel via the digital outside line interface;
a connection signal detector, which detects whether a line connection acknowledgment is received from the digital communications line after an outside line is seized by the digital outside line interface and dial signal transmission by the dial signal transmitter;
a switch controller, which connects an extension station and the voice channel of the digital communications line once the connection signal detector has detected a connection signal;
a dial information storage controller, which sequentially stores the dial information received on the dial receiver into a storage unit, and once the connection signal detector has detected a connection signal, stores predetermined information into the storage unit, and once the dial receiver has received a dial signal, sequentially stores the received dial information into the storage means until the extension station which transmitted the dial signal releases the call; and
a redial controller, which controls so that, on predetermined input operation on an extension station, dial information stored before predetermined information of the dial information stored by the dial information storage controller will be output to the control channel of the digital communications line by the first dial signal transmitter and that dial information stored after the predetermined information will be output to the voice channel of the digital communications line by the second dial signal transmitter after an acknowledgment from the digital communications line is detected by the connection signal detector.

8. The PBX according to claim 7, wherein:
the second dial signal transmitter converts dial information stored after the predetermined information to a DTMF signal and outputs the DTMF signal to the voice channel of the digital communications line.

9. The PBX according to claim 7, further comprising:
a timing setting unit, which sets a timing of outputting dial information by the second dial signal transmitter;
wherein the redial controller, on detection of an acknowledgment from a digital communications line by the connection signal detector, outputs dial information stored after predetermined information to the voice channel of the digital communications line by the second dial signal transmitter based on the timing set by the timing setting unit.

10. The PBX according to claim 7, further comprising:
a dial storage condition storing unit, which stores the conditions on whether the dial information storage controller stores the dial information received by the dial receiver, into the storage unit, after a line connection acknowledgement from a digital communications line has been detected.

11. The PBX according to claim 7, further comprising:
an analog outside line interface, which connects to an analog communications line;
wherein, when outputting dial information from the analog outside line interface, the redial controller does not output dial information stored after predetermined information.

12. The PBX according to claim 11, wherein:
in case a predetermined operation is made on an extension station after dial information stored before predetermined information out of the dial information stored by the storage unit is output from the analog outside line interface, the redial controller outputs redial information stored after the predetermined information.

13. The PBX according to claim 7, wherein the predetermined information is mark information generated by the dial information storage unit based on detection of the line connection acknowledgement.

14. A telephone apparatus which can be connected to a digital communication line comprising at least a control channel and a voice channel, comprising:
a dial information storage controller, which sequentially stores dial information which is input from a input unit, into a storage unit and stores predetermined information into the storage unit on detecting a connection signal from the digital communications line and, in case further dial information is input from the input unit, sequentially stores the dial information into the storage unit until the call is released; and
a redial controller, which outputs dial information stored before the predetermined information of the dial information stored into the storage unit, to a voice channel of the digital communications line, and on detecting a connection signal from the digital communications line, outputs dial information stored after the predetermined information to a voice channel of the digital communication line.

15. The telephone apparatus according to claim 14, wherein the dial information to be output to the voice channel of the digital communications lines is a DTMF signal.

16. The telephone apparatus according to claim 14, further comprising:
a telephone directory storing dial information and destination information in relation to each other,
wherein, on input from the input unit, the dial information storage controller registers the dial information and destination information to the telephone directory.

17. The telephone apparatus according to claim 14, further comprising:
a dial storage condition storing unit, which stores conditions on whether the dial information storage controller stores the dial information which is input from the input unit, into the storage unit, after a connection signal from the digital communications line has been detected.

18. The telephone apparatus according to claim 14, further comprising:
an analog outside line interface, which connects to an analog communications line;
wherein, when outputting dial information from the analog outside line interface, the redial controller does not output dial information stored after predetermined information.

19. The telephone apparatus according to claim 14, wherein:
the predetermined information is mark information generated by the dial information storage unit based on detection of the connection signal.
